(19) United States
(12) Patent Application Publication
(10) Pub. No.: US 2006/0196948 A1
(43) Pub. Date: Sep. 7, 2006

(54) Light transmissive cards with suppression of UV-induced fluorescence

(76) Inventors: Michael F. Weber, Shoreview, MN (US); Diane North, Inver Grove Heights, MN (US); Stephanie B. Castiglione, Hudson, WI (US)

Correspondence Address: 3M INNOVATIVE PROPERTIES COMPANY, PO BOX 33427, ST. PAUL, MN, 55133-3427, US

(21) Appl. No.: 11/072,154

(22) Filed: Mar. 4, 2005

(51) Int. Cl. G06K 19/00; G06K 19/06

(52) U.S. Cl. 235/487; 235/491

(57) ABSTRACT

A visible light transmissive card includes a security indicia that fluoresces under UV light. The card also includes at least one IR filter. The IR filter and/or another card layer that is substantially coextensive with a front card surface includes a component that also fluoresces under UV light. A UV blocking material is disposed between the security indicia and the UV-excitable component of the IR filter or other layer, so that the security indicia is clearly visible when the card is exposed to UV light. In some embodiments the UV blocking material is patterned to define (in combination with the fluorescing IR filter or another coextensive card layer) a secondary security indicia, which may be used in addition to or in place of the original security indicia. IR filter laminates used in the construction of such cards are also disclosed.

### FIELD OF THE INVENTION

The present invention relates to cards, such as those carried for personal use. The invention has particular utility for those cards that are at least in part visible light transmissive.

### BACKGROUND

Recent trends in card fashions have created a demand for visible light transmissive cards (“VLT cards”), at least for financial transaction card applications. In this regard, a “card” refers to a substantially flat, thin, stiff article that is sufficiently small for personal use. Examples include but are not limited to financial transaction cards (including credit cards, debit cards, and smart cards), identification cards, and health cards. A VLT card refers to a card that has at least one area through which at least a portion of visible light is transmitted, which area has an average transmission (measured with an integrating sphere to collect all light scattered in forward directions through the card) over the range from 400 to 700 nm of at least 50%, more preferably at least 70% or even 80%. VLT cards can have a substantial amount of haze (and hence be translucent) and can be tinted or otherwise colored, such as by the incorporation of a dye or pigment, or by suitable placement of the reflection band of a multilayer optical film. VLT cards can also be substantially transparent and colorless, e.g., water-clear.

Such VLT financial transaction cards have a curious appearance that distinguishes them from other cards, namely, that if one is held up to a light source, some light will be noticeably transmitted through the card. Depending on the amount of haze and color of the VLT card, background objects may be visible through the card, and, if the card is placed on top of a paper or other document containing text or graphic illustrations, the text or graphic illustrations may be visible through the card. FIG. 1 shows a VLT card 10 in perspective view. The card has a front card surface 12, from which is visible certain embossed and/or printed information, such as a card number, name of the cardholder, and conventional printed information often including ornamental graphics. The card is transmissive to visible light, illustrated schematically by incident visible light 14 impinging on a back side of the card being transmitted, with a somewhat diminished intensity, into transmitted visible light 14a. The card 10 can also include other conventional features such as a signature stripe and signature, magnetic stripe, hologram(s), integrated circuit (IC) chip with or without contact pads. To the extent any of these features are disposed on or proximate the back side of the card 10, they are generally also visible from the front side.

It has also been known for some time now to incorporate infrared (“IR”) filters in the construction of VLT cards to make them compatible with card reading machines such as Automated Teller Machines (ATMs) and the like. (In this regard, infrared or IR refers to electromagnetic radiation whose wavelength is about 700 nm or more. This of course includes but is not limited to near infrared wavelengths from about 700 nm to about 2500 nm.) Such machines typically include edge sensors that utilize IR light in certain wavelength bands to detect the presence of the card. Unless the card blocks such IR light sufficiently, the edge sensor is not tripped and the card reading machine does not acknowledge the presence of the card. Some card manufacturing equipment also uses IR edge sensors; thus, cards produced on such equipment must also block the appropriate IR light. ISO standard No. 7810 (Rev. 2003) is believed to specify an optical density (OD)>1.3 (corresponding to <5% transmission) throughout the range 850-950 nm, and an OD>1.1 (corresponding to <7.9% transmission) throughout the range 950-1000 nm. The IR filter, which extends over substantially the entire card area, transmits visible light to at least some extent, and blocks (e.g. by reflection or absorption) IR light in the wavelength bands used by the IR edge sensors. In FIG. 1, the IR filter is depicted as a central layer 16 of the card 10. IR light 18 incident on the back side of the card may be reflected and/or absorbed, but it is not substantially transmitted through the card.

### BRIEF SUMMARY

The present application discloses, inter alia, VLT cards that comprise a security indicia. Often, the security indicia is a specially printed ink or like material that is not noticeable under normal daytime lighting conditions, but that fluoresces when exposed to a UV light source to reveal a pattern, alphanumeric text, logos, symbols, graphics, or other indicia that can be used for purposes of authentication. The card also includes a first coextensive card layer, which may be an IR filter and/or other card layers, that contains a component that also fluoresces under UV light. The card therefore also includes a UV blocking material disposed between the security indicia and the first coextensive card layer. The UV blocking material can be uniformly dispersed in another coextensive card layer, such that little or no fluorescence from the first coextensive card layer is observed when the card is exposed to UV light. Alternatively, the UV blocking material can be nonuniformly dispersed in such other coextensive card layer, or dispersed in a printed or otherwise patterned layer, such that the resulting patterned UV blocking material in combination with the first coextensive card layer provide a secondary security indicia that can be viewed by exposing the card to UV light. In some cases, the original security indicia can be eliminated in favor of this secondary indicia.

The application also discloses IR filter laminates useable in the construction of such VLT cards.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a perspective view of a visible light transmissive card;

FIG. 2 is a greatly magnified perspective view of a known multilayer optical film;

FIG. 3 is a perspective view of a visible light transmissive card containing security indicia that fluoresce on exposure to UV light, and also containing an IR filter that also fluoresces on exposure to UV light;

FIG. 4 is a schematic sectional view of a portion of a VLT card, showing selected components thereof;

FIG. 5 is a schematic sectional view of a portion of a laminate construction containing an IR filter, the laminate construction being useable in the VLT card of FIG. 4 and other VLT cards;

FIG. 6 is a perspective view of a patterned layer of UV blocking material; and

FIG. 7 is a perspective view of a VLT card incorporating the patterned material of FIG. 6 and an IR filter that fluoresces on exposure to UV light.

### DETAILED DESCRIPTION OF THE ILLUSTRATIVE EMBODIMENTS

One type—but by no means the only type—of IR filter useable in VLT cards is a reflective filter that is or comprises a multilayer optical interference film made by any known technique but preferably by coextrusion of alternating polymer layers. See, e.g., U.S. Pat. No. 3,610,724 (Rogers); U.S. Pat. No. 3,711,176 (Alfrey, Jr. et al.), “Highly Reflective Thermoplastic Optical Bodies For Infrared, Visible or Ultraviolet Light”; U.S. Pat. No. 4,446,305 (Rogers et al.); U.S. Pat. No. 4,540,623 (Im et al.); U.S. Pat. No. 5,448,404 (Schrenk et al.); U.S. Pat. No. 5,882,774 (Jonza et al.) “Optical Film”; U.S. Pat. No. 6,045,894 (Jonza et al.) “Clear to Colored Security Film”; U.S. Pat. No. 6,531,230 (Weber et al.) “Color Shifting Film”; U.S. Pat. No. 6,783,349 (Neavin et al.), “Apparatus For Making Multilayer Optical Films”; and PCT Publication WO 99/39224 (Ouderkirk et al.) “Infrared Interference Filter”. See also PCT Publication WO 03/100521 (Tait et al.), “Method For Subdividing Multilayer Optical Film Cleanly and Rapidly”. In such polymeric multilayer optical films, polymer materials are used predominantly or exclusively in the makeup of the individual layers. Such films are compatible with high volume manufacturing processes, and can be made in large sheets and roll goods.

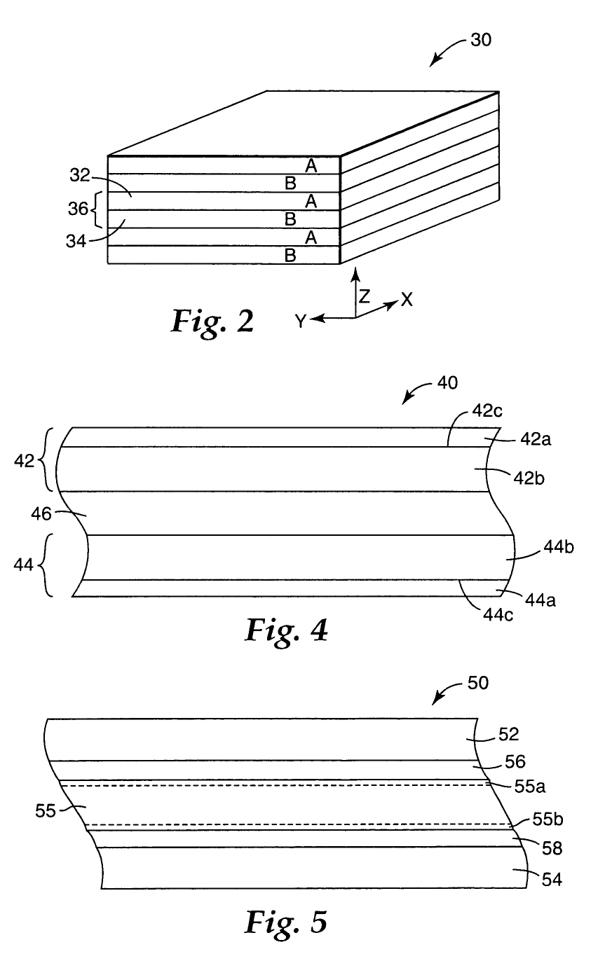

FIG. 2 depicts a conventional multilayer optical film 30. The film comprises individual microlayers 32, 34. The microlayers have different refractive index characteristics so that some light is reflected at interfaces between adjacent microlayers. The microlayers are sufficiently thin so that light reflected at a plurality of the interfaces undergoes constructive or destructive interference in order to give the film the desired reflective or transmissive properties. For optical films designed to reflect light at ultraviolet, visible, or near-infrared wavelengths, each microlayer generally has an optical thickness (i.e., a physical thickness multiplied by refractive index) of less than about 1 μm. Thicker layers can, however, also be included, such as skin layers at the outer surfaces of the film, or protective boundary layers disposed within the film that separate packets of microlayers.

The reflective and transmissive properties of multilayer optical film 30 are a function of the refractive indices of the respective microlayers. Each microlayer can be characterized at least in localized positions in the film by in-plane refractive indices nₓ, n_{y}, and a refractive index nz associated with a thickness axis of the film.

These indices represent the refractive index of the subject material for light polarized along mutually orthogonal x-, y-, and z-axes, respectively (see FIG. 2).

In practice, the refractive indices are controlled by judicious materials selection and processing conditions. Film 30 can be made by co-extrusion of typically tens or hundreds of layers of two alternating polymers A, B, followed by optionally passing the multilayer extrudate through one or more multiplication die, and then stretching or otherwise orienting the extrudate to form a final film. The resulting film is composed of typically tens or hundreds of individual microlayers whose thicknesses and refractive indices are tailored to provide one or more reflection bands in desired region(s) of the spectrum, such as in the visible or near infrared. In order to achieve high reflectivities with a reasonable number of layers, adjacent microlayers preferably exhibit a difference in refractive index (Δnₓ) for light polarized along the x-axis of at least 0.05. If the high reflectivity is desired for two orthogonal polarizations, then the adjacent microlayers also preferably exhibit a difference in refractive index (Δn_{y}) for light polarized along the y-axis of at least 0.05.

If desired, the refractive index difference (Δnₓ) between adjacent microlayers for light polarized along the z-axis can also be tailored to achieve desirable reflectivity properties for the p-polarization component of obliquely incident light. For ease of explanation, at any point of interest on a multilayer optical film the x-axis will be considered to be oriented within the plane of the film such that the magnitude of Δnₓ is a maximum. Hence, the magnitude of Δn_{y} can be equal to or less than (but not greater than) the magnitude of Δnₓ. Furthermore, the selection of which material layer to begin with in calculating the differences Δnₓ, Δn_{y}, Δnₓ is dictated by requiring that Δnₓ be non-negative. In other words, the refractive index differences between two layers forming an interface are Δnⱼ=n₁ⱼ−n₂ⱼ, where j=x, y, or z and where the layer designations 1,2 are chosen so that n₁ₓ≧n₂ₓ., i.e., Δnₓ≧0.

To maintain high reflectivity of p-polarized light at oblique angles of incidence, the z-index mismatch Δn_{z} between microlayers can be controlled to be substantially less than the maximum in-plane refractive index difference Δnₓ, such that Δn_{z}≦0.5*Δnₓ. More preferably, Δn_{z}≦0.25*Δnₓ. A zero or near zero magnitude z-index mismatch yields interfaces between microlayers whose reflectivity for p-polarized light is constant or near constant as a function of incidence angle. Furthermore, the z-index mismatch Δnₓ can be controlled to have the opposite polarity compared to the in-plane index difference Δnₓ, i.e. Δnₓ<0. This condition yields interfaces whose reflectivity for p-polarized light increases with increasing angles of incidence, as is the case for s-polarized light.

Alternatively, the multilayer optical film can have a simpler construction in which all of the polymeric microlayers are isotropic in nature, i.e., nₓ=n_{y}=n_{z} for each layer. Furthermore, known self-assembled periodic structures, such as cholesteric reflecting polarizers and certain block copolymers, can be considered multilayer optical films for purposes of this application. Cholesteric mirrors can be made using a combination of left- and right-handed chiral pitch elements.

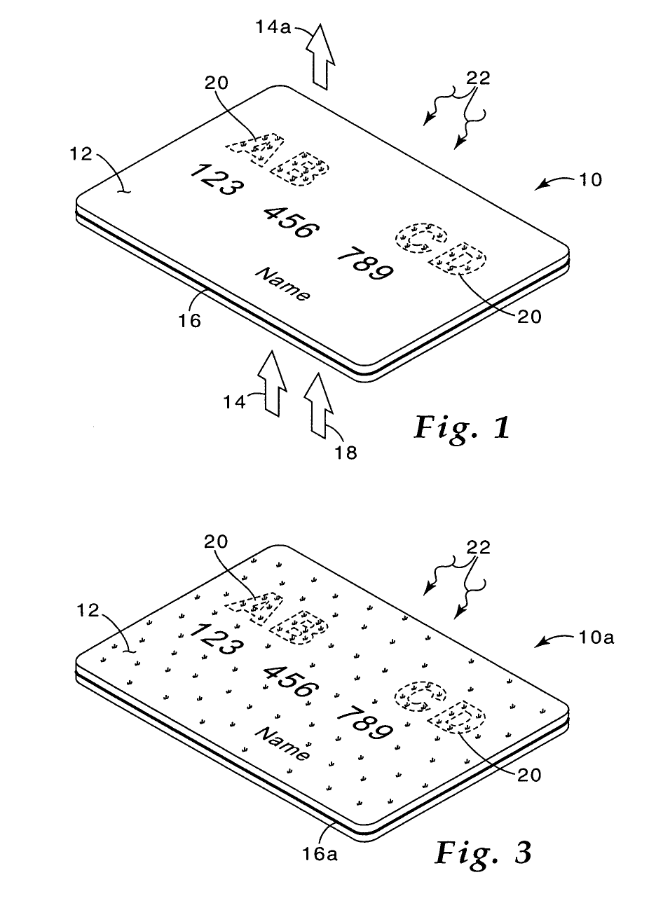

Financial transaction cards (whether or not they are VLT), particularly credit cards, also typically contain a variety of security features designed to make forgery of the cards extremely difficult. One such security feature is a hologram visible on the front side of the card. Another such security feature is alphanumeric text or graphics that are not visible under normal daytime lighting conditions, but that become clearly visible if the card is placed underneath an ultraviolet (UV) lamp, sometimes referred to as a black light. Such text or graphics, referred to herein as “security indicia”, is printed on the card with a known ink or other material that is substantially transparent over the visible wavelengths, making the security indicia substantially invisible under normal daytime lighting conditions, but that absorbs at least some UV wavelengths and re-emits the absorbed energy as fluorescence in the visible wavelength range, making the security indicia clearly visible when exposed to UV light. In FIG. 1, the security indicia, shown as indicia 20, becomes visible when the front side of the card 10 is illuminated with UV light 22. Often the security indicia is or comprises a name, abbreviation, logo, or insignia of the card issuer, such as a financial institution or credit card company. The security indicia can also comprise text, abbreviations, logos, or insignia associated with other business institutions, government bodies, universities, health card providers, and the like.

In some cases, the IR filter used to make the VLT card light transmissive in the visible but substantially opaque to certain IR wavelengths may inadvertently include a component that fluoresces under UV light. When the VLT card is then placed under UV light in order to observe the security indicia, the fluorescence generated by the component in the IR filter over substantially the entire card surface may have an intensity and color similar to that of the security indicia, making the security indicia difficult or impossible to observe. This situation is depicted in FIG. 3, where a VLT card 10a is shown in perspective view. VLT card 10a is similar to that of card 10, except that card 10a includes an IR filter 16a that includes a component that substantially fluoresces when exposed to UV light 22. Hence, when the card is illuminated with UV light 22, both the security indicia 20 and the remainder of the card area emit fluorescent light similar in intensity and color, rendering the security indicia substantially unobservable.

Whether or not the IR filter substantially fluoresces on exposure to UV light can depend greatly on the particular polymers or other materials selected for its construction. Multilayer optical interference films such as those described above are constructed with alternating layers of materials with high and low indices of refraction. A very high reflectivity interference film requires a large refractive index differential between the alternating layers, or a very large number of layers, or a combination of both. With an all polymer film, polyethylene terephthalate (PET) and polyethylene naphthalate (PEN) are exemplary high refractive index polymers. The refractive indices of amorphous PET and PEN are relatively high (about 1.57 and 1.64 respectively), but even higher in-plane refractive indices arise when the films are biaxially stretched or otherwise oriented. With proper stretch conditions, the in-plane indices of biaxially stretched PET and PEN can be increased to about 1.65 and 1.75 respectively. Oriented copolymers of PET and PEN (i.e., coPENs) span the range of refractive indices between these respective endpoints. For purposes of this application we intend the term coPEN to include not only copolymers of PEN but also pure PEN. The choice of polymer for the low index layers depends on a number of factors including: stability at the relatively high processing temperatures required; the ability to be coextruded with the high index polymer in a manner that provides good laminar flow of the extrudate; acceptable adhesion to the high index polymer; and ability to be stretched at the desired orientation temperature of the high index polymer.

One suitable polymer combination for making the IR reflective multilayer optical film is PET for the high refractive index polymer and a copolymer of polymethyl methacrylate (“coPMMA”) as the low refractive index polymer. After coextrusion, casting, and biaxial stretching, the coPMMA layers can have refractive indices nₓ=n_{y}=n_{z}=1.49, and the PET layers can have in-plane indices nₓ=n_{y}=1.65, and an out-of-plane index n_{z}=1.49. Films made with this polymer combination, having outer PET skin layers each nominally 12-13 μm thick, and a single central packet of 275 microlayers characterized by a thickness gradient, have exhibited IR reflectivities of 95% or more, and average normal-incidence transmission over visible wavelengths of 80% or more.

Notably, neither PET nor coPMMA exhibit substantial fluorescence when exposed to UV light. Hence, unless the IR filter includes some other component that substantially fluoresces, the phenomenon depicted in FIG. 3 does not arise with an IR filter composed of PET/coPMMA polymers.

Another suitable polymer combination for making the IR reflective multilayer optical film is coPEN for the high refractive index layer and coPET for the low refractive index layer. (In this regard, coPET for purposes of this application refers to a copolymer of polyethylene terephthalate or polyethylene isothalate that has a refractive index (after film orientation, if applicable) no greater than the refractive index of amorphous polyethylene terephthalate or polyethylene isothalate respectively.) This polymer combination can yield IR filters that are preferred over those made with the PET/coPMMA combination. CoPEN and coPET can have good coextrudability with good laminar flow of the melt stream, good temperature stability at the extrusion temperature, and good interlayer adhesion. PETG (Eastman Eastar 6763) and PCTG (Eastman Eastar 5445), both available from Eastman Chemical Company, Kingsport, Tenn., are particularly suitable coPET materials, even though their refractive indices are not as low as some other polymer choices. For the high index coPEN, a 90/10 wt % ratio of PEN to PET is particularly suitable. This coPEN composition has a refractive index of about 1.72 when biaxially oriented, and can be extruded at temperatures typically used for pure PET, which are lower than those required for pure PEN. These lower extrusion temperatures can reduce the requirements demanded of the low refractive index polymer.

Notably, both pure PEN and the 90/10 coPEN composition emit substantial fluorescence upon exposure to UV light. In particular, UV light whose wavelength is below about 385 nm, including UV light whose wavelength is at or near the 365 nm mercury emission line, causes substantial fluorescence in PEN and in 90/10 coPEN. The fluorescent emission extends over a range of wavelengths in the visible, typically from about 400-500 nm, peaking at about 425 nm. This emission exhibits a blue-violet color, which color is the same as or similar to the emission of some UV-excitable inks used for security indicia. Hence, the phenomenon depicted in FIG. 3 can arise with an IR filter composed of 90/10 PET/coPMMA polymers.

The phenomenon of FIG. 3 can also occur if any other constituent layer of the card (whether or not it is an IR filter, but excluding the security indicia itself) contains a component that happens to produce UV-excited fluorescence of a type that obscures a security indicia. For example, an adhesive layer that is not an IR filter but that is disposed within the card construction may contain an ingredient that fluoresces under UV light. Such constituent card layers, and usually including the IR filter, are characterized by being substantially coextensive with the front card surface (for example, they may extend to all edges of a card), and are referred to as coextensive card layers. Because they are substantially coextensive with the front card surface, fluorescence emitted from such a layer extends over substantially the entire card surface, thus obscuring the security indicia. (Note that if only a portion of the card is visible light transmissive, then “substantially the entire card surface” and like terminology refers to only such portion. In cases where a hole or cavity is formed in a group of otherwise coextensive card layers in order to embed a IC chip in the card, such layers are still considered to be substantially coextensive with the front card surface.) In the description that follows, the IR filter is treated as the only coextensive card layer that contains a UV-excitable component. The reader will understand, however, that other coextensive card layers may also include such a component, whether or not the IR filter also does.

There are a variety of ways to deal with a fluorescing IR filter, such as the coPEN/coPET combination disclosed above, to avoid the phenomenon depicted in FIG. 3. In some cases it may be possible to simply increase the brightness of the security indicia (for example by selecting or formulating a brighter or higher concentration UV ink, or by printing a thicker layer of the UV ink) so that the background fluorescence from the IR filter is no longer obscuring. Before addressing other ways, however, we provide some background and further description regarding possible IR filter designs, including IR filter laminate constructions that can be useful in the manufacture of VLT cards.

Normally, the various layers making up a card construction are converted (processed) into large sheets, which are then heat laminated together to form a large, relatively stiff “card sheet”. Tens or hundreds of individual cards are then cut or stamped out of the card sheet. The cards can also include integrated circuit chips, signature stripes, magnetic stripes, and so on. FIG. 4 shows a sectional view of a portion of a VLT card sheet or card 40. Card 40 includes relatively thick card stock layers 42, 44, which can have multiple components and in fact are shown as including thin clear overlay films 42a, 44a, and thicker primary card stock layers 42b, 44b. Layers 42, 44 are usually at least about 5 mils (125 μm) thick, and are typically on the order of 10 mils (250 μm) or more. Overlay films 42a, 44a, if present, are usually on the order of about 1 mil (25 μm) thick. If ordinary printed alphanumeric or graphic information or ornamentation is present on the card 40, it is usually placed at the interfaces labeled 42c and 44c, which as shown are protected from abrasion and other environmental degradation by overlay films 42a, 44a. The transparent UV-excitable inks forming the security indicia can also be placed at one or both interfaces 42c, 44c, for example by printing onto the surface of the primary card stock layers before application of the overlay films.

The VLT card 20 also includes an IR filter 46. The IR filter is shown sandwiched symmetrically between the remaining card-forming layers, which is generally helpful in avoiding warping problems. Such central placement of the IR filter, however, is not required. If desired, the IR filter can be asymmetrically positioned with respect to the other card layers, and can even be laminated or applied to one side of the card. If desired a balancing polymer layer can be applied to the other side of the card for anti-warp purposes. Alternatively, IR filters can be applied to both sides of the card to provide a symmetrical structure. More generally, multiple IR filters can be incorporated into the card construction.

The IR filter is normally coextensive with the other card layers—i.e., it extends to all edges of a finished card. FIG. 4 depicts the IR filter as consisting essentially of single layer. In some cases, the IR filter for a VLT card may indeed consist essentially of a single layer coated onto another layer of the card construction, or formed into a single layer film and laminated to or between one or more other layers of the card construction. Materials selection for the IR filter and the adjacent layers of the card construction should preferably ensure adequate adhesion so that delamination of the card does not occur in normal use.

In some cases, the IR filter can be bonded or otherwise joined to additional layers in an intermediate article referred to herein as an IR filter laminate, to facilitate manufacturability of the cards. For example, the IR filter laminate can have outer polymer layers selected to match adjacent polymer layers of the card sheet construction that they will be in contact with, to ensure reliable fusing of the polymer materials during heat lamination. Also, to the extent the IR filter itself is too thin or limp to easily manipulate, incorporating it into an IR filter laminate can improve processability and material handling. FIG. 5 shows a cross sectional view of a portion of an IR filter laminate 50. IR filter laminate 50 includes thin outer polymer layers 52, 54, preferably composed respectively of polymers that are the same as those used in primary card stock layers 42b, 44b if the laminate 50 is to be substituted for IR filter 46 in FIG. 4. Outer layers 52, 54 are normally less than 5 mils (125 μm) in thickness, typically 1 to 2 mils (25 to 50 μm). In some embodiments, layers 42b, 44b, 52, and 54 can all comprise or consist essentially of polyvinyl chloride (PVC). Instead, other materials such as PETG or PET can be used to reduce PVC content or to improve card durability. An IR filter 55 is sandwiched between the outer layers and adhered thereto by adhesive layers 56, 58 as shown. Such adhesive layers can comprise pressure sensitive adhesives (PSAs), hot melt adhesives, photocurable adhesives, and other known adhesive types. The IR filter 55 can be or comprise the multilayer optical films described above. Alternatively, the IR filter 55 can be or comprise a single layer or coating such as a coating that contains one or more IR absorbing dyes. The adhesive layers preferably comprise an adhesive that is aggressive, but relatively soft, transparent, and low haze, and that can survive lamination temperatures and pressures, commonly, 100 to 200 psi at temperatures as high as 285° F. (141° C.). Transilwrap 3/1 and 2/1 ZZ available from Transilwrap Company of Franklin Park, Ill., and Quest PVC 4(3/1)A available from Quest Films Inc. of Woodstock, Ill., are representative examples. Reference is made to pending U.S. Application No. 60/573,583, “Cards and Laminates Incorporating Multilayer Optical Films”, filed May 22, 2004.

With this background, we now return to various ways of dealing with the phenomenon depicted in FIG. 3, in which the security indicia 20 becomes difficult or impossible to observe under UV light because the fluorescing IR filter obscures the fluorescing security indicia.

In one class of approaches, UV light is prevented from reaching the fluorescing component of the IR filter, but not from reaching the security indicia. In these approaches, a layer of UV blocking material, which may be UV absorbing, scattering, and/or reflecting, is positioned within the card between the security indicia and the fluorescing component of the IR filter. The UV blocking material is present in an amount sufficient to eliminate or at least substantially reduce the level of fluorescence observed from the IR filter compared to the security indicia. In some cases the UV blocking material is incorporated into an already functional layer of the card construction as described above. In other cases, it is incorporated into an additional layer that is coated or otherwise applied to one or more of the existing layers.

In one such approach, for example, UV blocking material is loaded into adhesive layers that attach the IR filter or portion thereof that contains the UV-excitable component to other card layers. Adhesive layers 56 and 58 of FIG. 5 are examples. An advantage of this approach is not adding layers to the card construction, therefore not complicating the construction of the card and not adding additional interfaces that could detract from transparency, delaminate, or otherwise fail. Since the adhesive layers are often thousands of nanometers thick, and often at least about 0.5 mils (about 10 μm) or even 1 mil (25 μm) thick or more, another advantage is that the weight or volume percent loading of the UV blocking material can be relatively low and still block UV light effectively. If a security indicia is present only proximate the front side of the card and not the back side, then the UV blocking material can be loaded into only one of adhesive layers 56, 58, although the orientation of the IR filter laminate will in that case need to be correct during card construction so that the adhesive layer having the UV blocking material is disposed between the UV-excitable component of the IR filter and the security indicia. Alternatively, UV blocking material can be loaded equally into both adhesive layers 56, 58 even though a security indicia is included on only one side of the card. This produces a symmetrical IR filter product and simplifies card fabrication.

In another approach, UV blocking material can be loaded into one or more tie or primer layers that may already be included in the card design. Tie layers and primer layers may be included in the card construction to promote adhesion by modifying surface properties, for example at the interface between layer 42b and IR filter 46 or between layer 44b and IR filter 46, or on the outer surfaces of IR filter laminate 50 or of IR filter 55 in FIG. 5. This again would have the advantage of not adding layers to the card construction. However, tie layers and primer layers tend to be relatively thin, on the order of about a few micrometers or less, which would require a high volume or percent loading of the UV blocking material. The blocking material can be included in one or more such layers symmetrically or asymmetrically in the film construction, as explained above in connection with adhesives.

In still another approach, where the IR filter includes a multilayer optical film such as those described above, UV blocking material can be loaded into one or more layers of the multilayer optical film. For example, where the film includes coextruded alternating polymer microlayers and thicker outer skin layers, the UV blocking material can be loaded into the polymer(s) that forms the skin layers. Such skin layers are depicted and identified as items 55a, 55b in FIG. 5. In the coextrusion of multilayer polymeric film, the outer skin layers can be formed from the same polymer melt streams that form the alternating optically thin microlayers (see layers A, B in FIG. 2), or from only one of those melt streams, or from a completely separate melt stream using one of the polymers A, B, or a third polymer C. In the latter case the UV blocking material can be loaded into the melt stream forming the outer skin layers 55a, 55b without loading it into the layers making up the packet of microlayers. Alternatively, the UV blocking material can be loaded into one or both of the meltstreams forming the packet of microlayers. In the case of a multilayer optical film that comprises one set of microlayers that fluoresce and another set of microlayers that does not, such as with the 90/10 coPEN-coPET film construction described above, the UV blocking material can be loaded into the fluorescing (e.g. PEN or coPEN) layers, the non-fluorescing (e.g. PET or coPET) layers, or both. Adding the UV blocking material to one or more layers of the multilayer optical film again has the advantage of not adding layers and thus complexity to the card construction. As before, the blocking material can be included in one or more such layers symmetrically or asymmetrically.

The UV blocking material can also be loaded into any other layer of the card construction disposed between the security indicia and the fluorescing component of the IR filter. For example, the UV blocking material can be loaded into a primary cardstock layer 42b (FIG. 4) or an outer polymer layer 52 (FIG. 5) of an IR filter laminate. However, special manufacturing runs of such materials, in order to incorporate a suitable UV blocking material therein in an appropriate amount, can involve significant added expense.

As mentioned above, the UV blocking material can also be included in one or more additional layers added to the card construction between the security indicia and the UV-excitable component of the IR filter. Such a layer can be coated onto or laminated to any other suitable disposed card layer. For example, a layer of UV blocking material can be coated onto one or both outer surfaces of an IR filter laminate such as that of FIG. 5, making an asymmetric or symmetric modified filter laminate. Such a layer can also be coated onto one or both outer surfaces of a multilayer optical film, or to one or more other surfaces of an IR filter laminate such as the inner surfaces of outer polymer layers 52, 54 in FIG. 5. The UV blocking material can also be included in a layer proximate the security indicia, for example, at the interface 42c in FIG. 4. In that case, before applying the overlay film 42a to the surface of primary cardstock layer 42b, the UV blocking material can be coated onto such surface of layer 42b, followed by printing of the security indicia atop the UV blocking material layer. Standard printing can also be included at the interface 42c or at another interior or exterior surface of the card.

The foregoing examples are not intended to be limiting, and the reader will understand that the UV blocking material can be included elsewhere in VLT card constructions as desired. The UV blocking material in the foregoing description is however preferably substantially transparent to most or all of the visible wavelength region so that it does not substantially detract from the light transmitting properties of the card. However, the UV blocking material may absorb or otherwise block some visible wavelengths such that it imparts a color or changes the perceived color of the card. More discussion is provided below on suitable UV blocking materials.

The examples discussed above assume that the UV blocking material is provided in one or more uniform, continuous layers that extend over substantially the entire card area, thus suppressing fluorescence from substantially the entire IR filter when illuminated with UV light from a particular side of the card. The resulting card has the appearance of card 10 in FIG. 1, even though the IR filter includes a material that fluoresces under UV light. This is because the UV blocking material is disposed uniformly and continuously to block UV light from reaching any portion of the IR filter, at least for UV light incident from one side of the card.

Another class of approaches to deal with the phenomenon of FIG. 3 adds the UV blocking material nonuniformly over the card area, such as in a discontinuous or patterned fashion in an otherwise uniform layer, or in a layer that is itself patterned, printed, or otherwise discontinuous, in order to suppress fluorescence from only selected portion(s) of the IR filter when illuminated with UV light from a particular side of the card. The nonuniform UV blocking material in combination with the fluorescing IR filter can be used to provide a secondary security indicia, which can be used in addition to the original security indicia or which can even replace the original security indicia.

Thus, each of the examples discussed above can be modified by making the UV blocking material nonuniform over the card area. This is most readily done by simply applying the UV blocking material by a printing process or the like to one or more of the other layers of the card construction.

For example, the UV blocking material can be applied at the interface 42c in FIG. 4. Before applying the overlay film 42a to the surface of primary cardstock layer 42b, the UV blocking material can be printed in a pattern onto such surface of layer 42b. If the original security indicia is also included, it can be printed atop portions of the pattern where the UV blocking material is present. In either case, the patterned UV blocking material can define a positive or negative image (e.g., background or foreground) of alphanumeric characters, logos, symbols, graphics, or any other indicia. The UV blocking material can alternatively be printed on one or both outer surfaces of the IR filter laminate, if one is used in card construction, or on inner surfaces thereof so long as at least some of the UV blocking material is disposed between an outer surface of the finished card and the UV-excitable component of the IR filter (and, if the original security indicia is present, between that security indicia and the UV-excitable component of the IR filter).

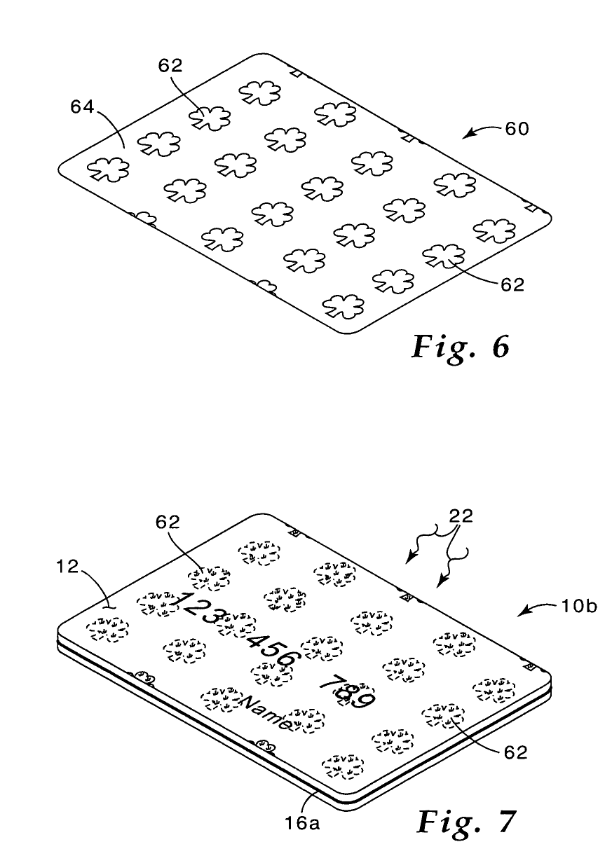

FIG. 6 shows one possible patterned layer 60, having the same lateral dimensions as the VLT card 10a of FIG. 3 and intended for use in such a card or a modified version thereof (but shown disembodied therefrom for convenience). In patterned layer 60, a pattern is defined by a foreground of an array of repeating symbols 62 and a background 64. To create a positive image, the UV blocking material can be present solely or preferentially in the background 64, whereupon the foreground symbols 62 become windows through which portions of the fluorescing IR filter can be seen. To create a negative image, the UV blocking material can be present solely or preferentially in the foreground symbols 62, whereupon the background 64 becomes a window through which other portions of the fluorescing IR filter can be seen. In either case the patterned UV blocking material in combination with the fluorescing IR filter can provide a secondary security indicia as shown in the VLT card 10b of FIG. 7. Card 10b is similar to VLT card 10a of FIG. 3, except that the original security indicia 20 has been eliminated and a positive image version of the patterned layer 60 of FIG. 5 has been incorporated in the card between the IR filter 16a and the front card surface 12, yielding a secondary security indicia (and in this case the only security indicia) that becomes visible when the card is exposed to UV light 22.

The foregoing approaches use a UV blocking material to prevent UV light from reaching all or a portion of the IR filter. In other approaches, a fluorescence quencher is incorporated into the portion of the IR filter that contains the UV-excitable component, such as the PEN or coPEN layers of a polymeric multilayer optical film. The fluorescence quencher suppresses fluorescent emission from a material without blocking the excitation light. In some cases it may nevertheless be desirable to use the fluorescence quencher in combination with a UV blocking material, whether uniform or patterned, and in other cases it may be desirable to use the fluorescence quencher without any UV blocking material in the card construction. Additive materials that can quench the fluorescence of PEN down to the level of PET are described in EP 711,803 A2 (Kido et al.). Further fluorescence quenchers are described in U.S. Pat. No. 5,310,857 (Jones et al.), U.S. Pat. No. 5,391,701 (Jones et al.), and PCT Publication WO 96/19517 (Weaver et al.).

In still other approaches of dealing with the phenomenon of FIG. 3, the UV-excitable ink used to make the original security indicia (such as indicia 20 in FIGS. 1 and 3) can be selected to fluoresce at a color substantially different from the fluorescence emitted by the IR filter. UV-excitable inks are available in a variety of fluorescent colors, including blue, green, yellow, orange, and red. Thus, depending on the color of the fluorescence emitted by the IR filter, several different UV-excitable inks will be available that have substantially different colors than that of the IR filter for adequate contrast for an observer to perceive the security indicia. Indeed, high color contrast and even decorative fluorescent color combinations are possible. The result is a card that fluoresces in both the security indicia areas (e.g. areas 20 of FIG. 3) and in some or all other areas of the card (see e.g. FIG. 3), but where a difference in color between the respective areas makes the security indicia observable under UV light. This approach is preferably used without incorporating any UV blocking materials or any fluorescence quenchers in the card construction.

For those embodiments described above that do incorporate a UV blocking material, any currently-known or later-developed UV blocking material that is compatible with the construction of a VLT card can be used. Materials known in the art as “UVA”s (ultraviolet absorbers) are generally suitable. Such materials can typically be mixed in a binder, ink, adhesive, or other film-forming composition, including polymerizable (e.g. photopolymerizable) coating compositions. An exemplary UV blocking material is 5-trifluoromethyl-2-(2-hydroxy-3-alpha-cumyl-5-tert-octylphenyl)-2H-benzotriazole, available under product code CGL-139 from Ciba Specialty Chemicals, Tarrytown, N.Y. Other suitable UV blocking materials include: 2,2′-Dihydroxy-4-methoxybenzophenone, sold as Cyabsorb™ UV-24 light absorber by Cytec Industries Inc., West Paterson, N.J.; Cyabsorb™ UV-3638 light stabilizer (a benzoxazinone) also sold by Cytec Industries; Tinuvin 327 (a benzotriazole) sold by Ciba Specialty Chemicals; Tinuvin 360 (a dimeric benzotriazole) also sold by Ciba Specialty Chemicals; and Triazines such as Tinuvin 1577 or CGL-777, both sold by Ciba Specialty Chemicals. Further suitable UV blocking materials are described in US Patent Publication US 2004/0241469 A1 (McMan et al.).

Unless otherwise indicated, all numbers expressing feature sizes, amounts, and physical properties used in the specification and claims are to be understood as being modified by the term “about.” Accordingly, unless indicated to the contrary, the numerical parameters set forth in the present specification and claims are approximations that can vary depending upon the desired properties sought to be obtained by those skilled in the art utilizing the teachings disclosed herein.

Various modifications and alterations of this invention will be apparent to those skilled in the art without departing from the scope and spirit of this invention, and it should be understood that this invention is not limited to the illustrative embodiments set forth herein. All U.S. patents, patent applications, patent application publications, and other patent and non-patent documents referred to herein are incorporated by reference, to the extent they are not inconsistent with the foregoing disclosure.

What is claimed is:

1. A visible light transmissive card, comprising:
a UV-excitable security indicia;
a coextensive card layer comprising a component that fluoresces under UV light; and
a first UV blocking material disposed between the security indicia and the coextensive card layer.

2. The card of claim 1, wherein the coextensive card layer is an IR filter.

3. The card of claim 2, wherein the card further comprises a first adhesive layer that includes the first UV blocking material.

4. The card of claim 3, wherein the card further comprises:
a first and second polymer layer; and
a second adhesive layer;
wherein the IR filter is disposed between the first and second polymer layers, wherein the first adhesive layer is disposed between the first polymer layer and the IR filter, and wherein the second adhesive layer is disposed between the second polymer layer and the IR filter.

5. The card of claim 4, wherein the second adhesive layer comprises a second UV blocking material.

6. The card of claim 1, wherein the UV blocking material is disposed in a uniform layer that is substantially coextensive with the card surface.

7. The card of claim 1, wherein the component comprises PEN or coPEN.

8. The card of claim 2, wherein the IR filter comprises a multilayer optical film.

9. The card of claim 8, wherein the multilayer optical film includes coextruded first and second polymer material layers, and wherein the first polymer material forms outer skin layers of the multilayer optical film.

10. The card of claim 9, wherein the second polymer material fluoresces under UV light and the first polymer material does not substantially fluoresce under UV light, and wherein one of the outer skin layers comprises the first UV blocking material.

11. The card of claim 1, wherein the UV blocking material is present in an amount sufficient to reduce fluorescence from the coextensive card layer to a level substantially below that of the security indicia when the card is exposed to UV light to permit the security indicia to be clearly visible.

12. A visible light transmissive card having an outer card surface, comprising:
a coextensive card layer comprising a component that fluoresces under UV light; and
a patterned UV blocking material disposed between the coextensive card layer and the outer card surface to define a security indicia that becomes visible when the card is exposed to UV light.

13. The card of claim 12, wherein the coextensive card layer is an IR filter, and the IR filter is disposed between a first and second polymer layer.

14. The card of claim 13, wherein a first adhesive layer is disposed between the IR filter and the first polymer layer, and a second adhesive layer is disposed between the IR filter and the second polymer layer.

15. The card of claim 13, wherein the card further comprises conventional indicia visible under normal lighting conditions, and the patterned UV blocking material and the conventional indicia are disposed on the first polymer layer.

16. The card of claim 15, wherein the first polymer layer has a first major surface, and the patterned UV blocking material and the conventional indicia are disposed on the first major surface.

17. The card of claim 12, wherein the patterned UV blocking material defines a positive image.

18. The card of claim 12, wherein the patterned UV blocking material defines a negative image.

19. An IR filter laminate suitable for use in making light transmissive cards, comprising:
an IR filter comprising a component that fluoresces under UV light;
first and second outer polymer layers; and
first and second adhesive layers bonding the IR filter to the first and second outer polymer layers respectively;
wherein at least one layer of the laminate comprises a component that fluoresces under UV light; and
wherein the laminate further includes a UV blocking material disposed to reduce fluorescing of the component when the filter laminate is exposed to UV light.

20. The laminate of claim 19, wherein the IR filter comprises the component, and wherein the UV blocking material is disposed in at least one of the first and second adhesive layers.

21. The laminate of claim 19, wherein the IR filter comprises the component, and wherein the IR filter comprises a multilayer optical film, and the UV blocking material is disposed in at least some of the layers of the multilayer optical film.

22. The laminate of claim 21, wherein the multilayer optical film includes outer skin layers, and wherein the UV blocking material is disposed in the outer skin layers.
